(19) United States
(12) Patent Application Publication
(10) Pub. No.: US 2006/0154610 A1
(43) Pub. Date: Jul. 13, 2006

(54) Communications apparatus and method therefor

(76) Inventor: Moray Denham Rumney, Edinburgh (GB)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/328,409

(22) Filed: Jan. 9, 2006

(30) Foreign Application Priority Data
Jan. 11, 2005 (GB) 0500418.9

(51) Int. Cl. H04B 17/00

(52) U.S. Cl. 455/67.14

(57) ABSTRACT

A method, apparatus and system provides for pacing transmission of a series of stimulus signals from a first wireless communications apparatus and a second wireless communications apparatus by using an opposite transmission direction of a duplexing scheme to that used for transmitting one or more of the series of stimulus signals.

Foreign priority benefits under 35 U.S.C. §119 for the instant application are hereby claimed to Great Britain application 0500418.9, filed Jan. 11, 2005.

The present invention relates to a method of pacing transmission of a series of stimulus signals, for example, of the type used to test operation of wireless devices, such as cellular telephones. One example of testing operation of cellular telephones is during a manufacturing test or other test process. The present invention also relates to a wireless communications apparatus of the type, for example, capable of generating a series of stimulus signals and receiving response signals. The present invention further relates to a stimulus response measurement system.

### BACKGROUND

In the field of wireless communications, particularly cellular telecommunications, it is known to test wireless devices having RF transmit and RF receive capability, for example mobile handsets, as part of a manufacturing or other test process. Testing typically involves a series of RF test signals being communicated in both directions between a test station, or system, and a wireless device being tested (hereafter referred to as the “Device Under Test” or “DUT”). The results of the tests are recorded for quality assurance purposes and/or used for calibrating the DUT.

As part of a process of communicating the series of RF test signals between the test system and the DUT, it is necessary to synchronise the test system with the DUT. One known method of achieving synchronization uses industry standard over-the-air signalling associated with a radio standard being tested, for example the Global System for Mobile Communications (GSM) standard or the IS-95 standard. However, the over-the-air signalling is designed to handle the imperfect Radio Frequency (RF) channels encountered in a real communications network and so uses a number of error correction techniques that result in test methods using over-the-air signalling being relatively slow, taking hundreds of milliseconds to change from one test signal, or point, in the series of test signals to a next test point.

Another known method of achieving synchronisation overcomes the above latency problems, but requires a proprietary test mode and a proprietary physical test interface in the DUT. However, this method of DUT control can still be quite slow as it is often implemented using a serial communications bus, for example based on the RS-232 standard. A new dedicated physical interface could be developed to provide a much lower latency control mechanism but this would add significant cost to the design of the DUT and be unique in its mechanical, electrical and control aspects specific to a wireless device manufacturer, or even a specific wireless device model.

### SUMMARY

According to a first aspect of the present invention, there is provided a method of pacing transmission of a series of stimulus signals from a first wireless communications apparatus and a second wireless communications apparatus in accordance with a duplexing scheme having a first transmission direction and a second transmission direction, the method comprising: the first wireless communications apparatus transmitting a first stimulus signal as part of the series of stimulus signals to the second wireless communications apparatus in the first transmission direction or the second transmission direction; the second wireless communications apparatus receiving the first stimulus signal; and the second wireless communications apparatus transmitting a response signal to the first wireless communications apparatus in a remaining unused one of the first transmission direction or the second transmission direction.

The duplexing scheme may be a Frequency Division Duplexing scheme. Alternatively, the duplexing scheme may be a Time Division Duplexing scheme.

The series of stimulus signals may constitute a series of test points or vectors. The series of stimulus signals may be measured to determine parameters of a transmitter of the DUT, such as Error Vector Magnitude (EVM) or peak signal power. The series of stimulus signals may be used to provide reference signals to allow measurement of parameters of a receiver of the DUT. It will be appreciated by the skilled person, that an extension of the above described receiver test can be carried out in order to accommodate known so-called “loopback” tests, whereby a stimulus signal encoded with known test data, for example a Pseudo Random Bit Sequence (PRBS), is transmitted, for example, from the first wireless communications apparatus to the second wireless communications apparatus, the second wireless communications apparatus transmitting a response signal back to the first wireless communications apparatus, the signal transmitted back to the first wireless communications apparatus being encoded with the known test data from the stimulus signal as received by the second wireless communications apparatus thus allowing the first wireless communications apparatus to perform correlation between the data transmitted to the second wireless communications apparatus and the corresponding data received from the second wireless communications apparatus.

It should be noted that in the case of loopback testing, which by definition requires the transmission of looped-back test data, the term “unused” as applied to the first transmission direction or the second transmission direction is intended to mean unused for the purposes of carrying control data as described in more detail later herein.

The method may further comprise: encoding at least one of the stimulus signals with first information. The first information may relate to at least one test parameter of a stimulus signal to succeed the at least one of the stimulus signals. The at least one test parameter may be any one or more of: RF frequency, RF level, signal duration, modulation format and/or measurement type required.

A presence of the response signal may be indicative of readiness by the second wireless communications apparatus to receive a second, and subsequent, stimulus signal as part of the series of stimulus signals.

The response signal may be substantially free of signalling information. The response signal may comprise at least one RF pulse. The at least one RF pulse may have a duration appropriate for the radio technology being tested, for example equivalent to one timeslot.

The method may further comprise: encoding at least one of the response signals with the first or second information. The second information may relate to at least one result parameter of a previous measurement operation and/or at least one test parameter of a stimulus signal to succeed the at least one of the stimulus signals. The at least one result parameter may be information necessary for performance of a test process, including but not limited to any one or more: measurement error handling parameters and/or measurement result parameters. The at least one test parameter may be any one or more of: RF frequency, RF level, signal duration or modulation format.

No other stimulus signals may be transmitted between the first stimulus signal and the second stimulus signal.

According to a second aspect of the present invention, there is provided a test process for measuring wireless communications apparatus performance as set forth above in relation to the first aspect of the present invention.

According to a third aspect of the present invention, there is provided a computer program element comprising computer program code means to make a computer execute the method as set forth above in relation to the first aspect of the present invention.

The computer program element may be embodied on a computer readable medium.

According to a fourth aspect of the present invention, there is provided a wireless communications apparatus capable of generating a series of stimulus signals and operating in accordance with a duplexing scheme having a first transmission direction and a second transmission direction, the apparatus comprising: a processing resource coupled to a transmitter for transmitting a first stimulus signal as part of the series of stimulus signals to another wireless communications apparatus in the first transmission direction or the second transmission direction; wherein: the processing resource is coupled to a receiver and arranged to await, when in use, receipt of a response signal from the another wireless communications apparatus in a remaining unused one of the first transmission direction or the second transmission direction.

The response signal may be indicative of readiness by another wireless communications apparatus to receive a second and subsequent stimulus signal as part of the series of stimulus signals.

According to a fifth aspect of the present invention, there is provided a stimulus response measurement system comprising a first wireless communications apparatus capable of communicating a series of stimulus signals to a second wireless communications apparatus in accordance with a duplexing scheme providing a first transmission direction and a second transmission direction, the system comprising: the first wireless communications apparatus arranged to transmit, when in use, a first stimulus signal in the series of stimulus signals to the second wireless communications apparatus in the first transmission direction or the second transmission direction; the second wireless communications apparatus arranged to receive, when in use, the first stimulus signal; and the second wireless communications apparatus arranged to transmit, when in use, a response signal to the first wireless communications apparatus in a remaining unused one of the first transmission direction or the second transmission direction.

It is thus possible to provide a wireless communications apparatus, a stimulus response measurement system and a method of pacing transmission of a series of stimulus signals, that allows the measurement of stimulus signals at a rate that is dictated only by the response time of the wireless communications apparatus as opposed to a the slower speed of the aforementioned existing test techniques that rely on over-the-air signalling or other proprietary control methods. Additionally, the method, apparatus and system as set forth herein also being a low-cost solution since no dedicated low-latency and/or proprietary hardware interface is required.

### BRIEF DESCRIPTION OF DRAWINGS

At least one embodiment of the invention will now be described, by way of example only, with reference to the accompanying drawings, in which:

FIG. 1 is a schematic diagram of a test system that employs an embodiment of the invention;

FIG. 2 is a schematic diagram of a first wireless communications apparatus of FIG. 1;

FIG. 3 is a schematic diagram of a second wireless communications apparatus of FIG. 1; and

FIG. 4 is a flow diagram of a method of stimulus response testing in a first transmission direction by the first wireless communications apparatus of FIG. 2 and constituting a first embodiment of the invention;

FIG. 5 is a flow diagram of a method of stimulus response testing in the first transmission direction by the second wireless communications apparatus of FIG. 3 and constituting a second embodiment of the invention;

FIG. 6 is a flow diagram of a method of stimulus response testing in a second transmission direction by the first wireless communications apparatus of FIG. 3 and constituting a third embodiment of the invention; and

FIG. 7 is a flow diagram of a method of stimulus response testing in the second transmission direction by the second wireless communications apparatus of FIG. 2 and constituting a fourth embodiment of the invention.

### DETAILED DESCRIPTION

Throughout the following description identical reference numerals will be used to identify like parts.

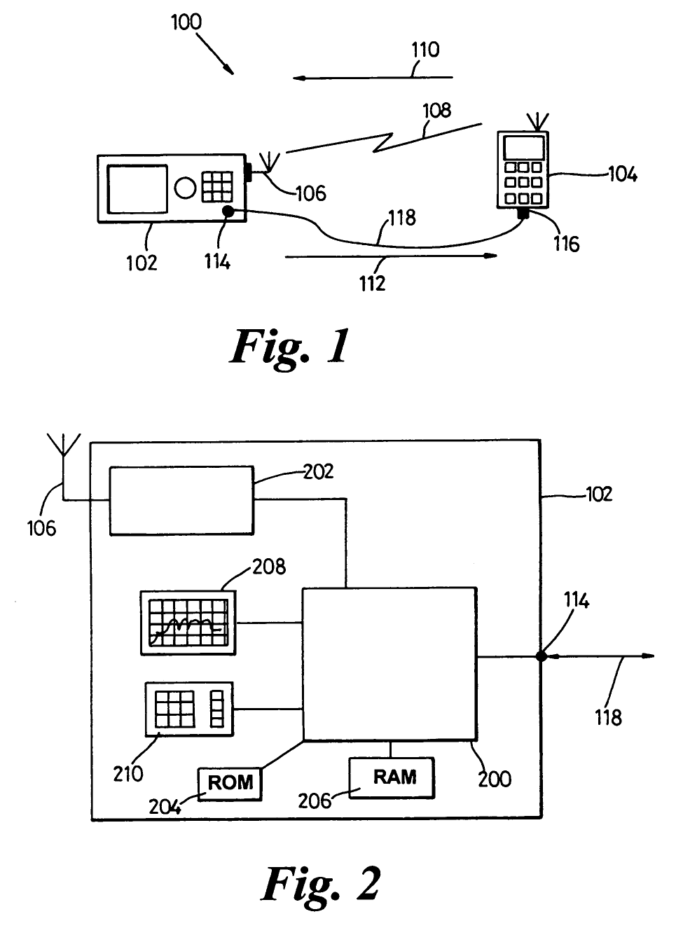

Referring to FIG. 1, a stimulus response system 100 comprises a first wireless communications apparatus, for example a test system 102 capable of communicating with a Device Under Test (DUT), for example a second wireless communications apparatus. In this example, the device under test is a wireless communications terminal, such as a cellular telecommunications terminal 104. The test system 102 comprises an antenna 106 for communicating with the terminal 104 via a Radio Frequency (RF) interface 108. In this example, the test system 102 and the terminal 104 operate in accordance with the Universal Mobile Telecommunications System (UMTS) Wideband CDMA (W-CDMA) FDD standard, though it should be appreciated that operation in accordance with other telecommunications standards is also possible, for example UMTS W-CDMA TDD, CDMA2000, GSM or IS-95. In relation to the UMTS standard employed, the terminal 104 is designed to operate under a duplexing scheme, in this example a Frequency Division Duplexing (FDD) scheme. Consequently, communications in a first transmission direction 110, in this example, from terminal 104 to the test system 102 is an uplink (or reverse link) direction, and communications in a second transmission direction 112, in this example, from the test system 102 to the terminal 104 is in a downlink (or forward link) direction. However, it should be appreciated that, in this example, the labels “uplink” and “downlink” specifically refer to the direction of communication with respect to the terminal 104, which in this example is a cellular communications terminal, and are provided for illustrative purposes only. From the perspective of the DUT, the first transmission direction 110 should be considered a transmit direction and the second transmission direction 112 should be considered a receive direction.

It should, of course, be appreciated that the terminal 104 need not be a cellular communications terminal and can be any suitable wireless communications apparatus with RF transmit and receive capability, for example a base station or Node B, that needs to be tested and/or calibrated.

The test system 102 also comprises an output communications port 114 and is coupled to a test input port 116 of the terminal 104 via a communications cable 118. In this example, the communications cable 118 is an RS-232 cable, but other methods of communication with the DUT other than through an RF receiver of the DUT will depend on the proprietary design of the DUT, for example a USB interface.

Turning to FIG. 2, the test system 102 is a model number 8960 wireless communications test set manufactured by Agilent Technologies, Inc. that has been appropriately adapted to provide functionality set out later herein. In the present example, the simplest way to adapt the test system 102 is through modification of software executed by the test system 102. However, it should be appreciated that the functionality can be achieved in hardware. Indeed, for other test systems, the functionality can be implemented in hardware and/or software.

The test system 102 comprises a first processing resource 200 coupled to an RF unit 202. In relation to the 8960 wireless communications test set, the first processing resource 200 comprises a number of individual processors, the exact number of processors depending upon the model variant used; different model variants exist for different test applications depending upon the processing requirements associated with the test application. However, the model variant is immaterial for the purposes of this example and so will not be described further herein.

The RF unit 202 is coupled to the antenna 106 and together they permit the test system 102 to communicate via the RF interface 108, the RF unit 202 being under the control of the first processing resource 200. The first processing resource 200 is also coupled to a non-volatile memory, for example a Read Only Memory (ROM) 204, and a volatile memory, for example a Random Access Memory (RAM) 206. A display 208 for displaying test results to a user is coupled to the first processing resource as well as a keypad 210 to allow the user to enter control commands to the test system 102.

The output communications port 114 is coupled to the first processing resource 200 in order to allow the first processing resource 200 to communicate with the terminal 104.

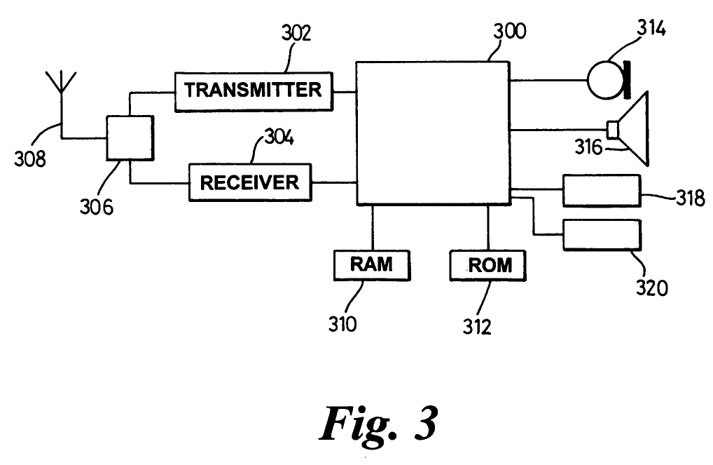

The terminal 104 (FIG. 3) comprises a second processing resource 300, the second processing resource 300 being, in this example, a chipset of the cellular communications terminal 104. The processing resource 300 is coupled to a transmitter chain 302 and a receiver chain 304, the transmitter and receiver chains 302, 304 being coupled to a duplexing filter 306. The duplexing filter 306 is coupled to an antenna 308.

The terminal 104 also possesses a volatile memory, for example a RAM 310, and a non-volatile memory, for example a ROM 312, each coupled to the processing resource 300. The processing resource 300 is also coupled to a microphone 314, a speaker unit 316, a keypad 318 and a display 320.

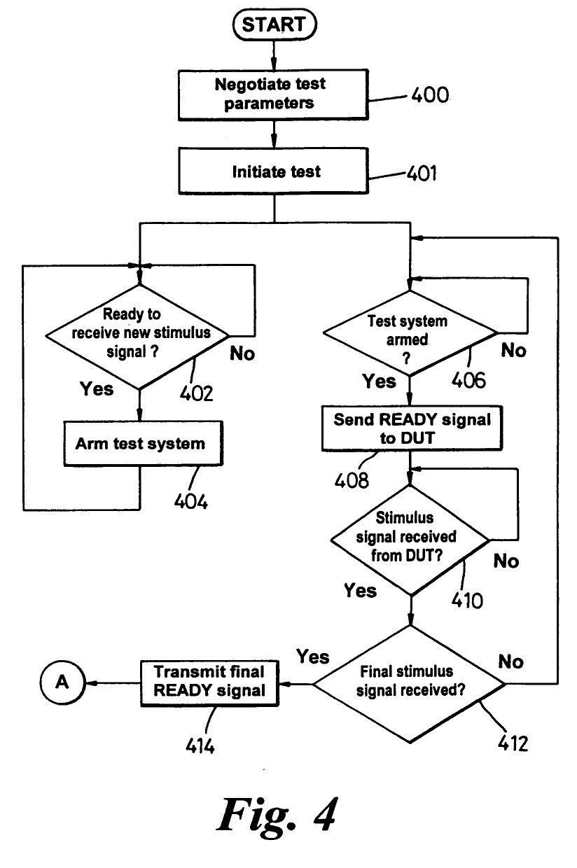

In operation (FIGS. 4 to 7), the test system 102 is used to test and calibrate the RF capabilities of the terminal 104. In this respect, an ability of the terminal 104 to transmit signals in the first transmission (DUT transmit) direction 110 and an ability of the terminal 104 to receive signals in the second transmission (DUT receive) direction 112 are both tested. Testing in the DUT transmit direction 110 is achieved by the terminal 104 transmitting a first series of stimulus signals to the test system 102 and the test system 102 measuring the first series of stimulus signals received by the RF unit 202 of the test system 102. Likewise, testing in the DUT receive direction 112 is achieved by the test system 102 transmitting a second series of stimulus signals to the terminal 104, the terminal 104 measuring the second series of stimulus signals received by the receiver chain 304 of the terminal 104. Each stimulus signal of the first and second series of stimulus signals constitutes a test point or vector having a predetermined RF frequency, amplitude and modulation format. In relation to the first series of stimulus signals, the one or more stimulus signal can, optionally, be encoded with control data as necessary, as described in more detail later herein. With respect to the second series of stimulus signals, it should be appreciated that it may be required to encode one or more stimulus signal of the second series of stimulus signals with known test data for the purpose of testing the receiver of the terminal 104. However, the one or more stimulus signal of the second series of stimulus signals can be further encoded with control data. In this example, the first series of stimulus signals are used to measure an Error Vector Magnitude (EVM) of the DUT by comparison of the measured stimulus signals with corresponding ideal values. However, they can for example be used to measure other parameters of the DUT such as peak power.

As a result of the need to measure RF capabilities of the terminal 104 in both its transmit and receive directions 110, 112, the stimulus response system 100 employs a two-part test. A first part of the test tests the ability of the terminal 104 to transmit signals in the DUT transmit direction 110, and a second part of the test tests the ability of the terminal 104 to receive signals in the DUT receive direction 112.

Referring to FIG. 4, before either of the first or second parts of the test can be commenced, a pre-configuration stage takes place. In relation to the first part of the test, i.e. where the transmission capabilities of the terminal 104 are being tested, the test system 102 firstly negotiates and/or communicates (400) test vectors constituting the first series of stimulus signals and the second series of stimulus signals to the terminal 104 via the communications output port 114, the test vectors constituting the first and second series of stimulus signals being stored locally in the test system 102 and can be entered through the keypad 210 or uploaded to the test system 102; the pre-configuration stage constitutes an agreement as to the first and second series of stimulus signals. The test system 102 then communicates (401) an INITIATE signal to the terminal 104 via the communications output port 114, thereby initiating the first part of the test. In this example, the INITIATE signal is used by the test system 102 to indicate to the terminal 104 a start of the first part of the test.

Thereafter, two separate processing threads are concurrently executed. A first thread addresses the issue of readiness of the processing resource in the test system 102 to receive stimulus signals. In this respect, in order to communicate readiness of the test system 102 to receive a first stimulus signal from the first series of stimulus signals, the test system 102 first needs to enter an “armed” state. The armed state cannot be entered until a part of the processing resource 200 responsible for processing received stimulus signals indicates readiness to receive the stimulus signals. Consequently, the part of the processing resource 200 responsible for processing stimulus signals regularly monitors itself to determine (402) whether it is able to receive stimulus signals. If the part of the processing resource 200 responsible for processing stimulus signals is ready to process a new stimulus signal, then the processing resource sets (404) an armed bit (not shown) to serve as a first armed flag indicative of the processing resource having entered into an “armed” state. On a second thread, another part of the processing resource responsible for communicating with the terminal 104 regularly monitors (406) the status of the first armed flag in order to determine when the processing resource 200 is in the armed state and hence ready to receive stimulus signals. If the processing resource 200 is in the armed state, then the test system 102 transmits (408) an armed or READY signal to the terminal 104 in the DUT receive direction 112 of the FDD scheme supported by the terminal 104. In this example, the READY signal is an RF signal having a predefined duration, amplitude and frequency. In relation to the FDD scheme employed in this example, the READY signal is transmitted at the downlink frequency associated with the uplink frequency of a first stimulus signal to be transmitted to the test system 102, the association being the duplex spacing of the UMTS system used. In this example, the READY signal is a simple signal having a predetermined RF amplitude with no further information content. However, in other examples, or in one or more subsequent READY signals, instead of using an unmodulated RF pulse as the READY signal, the READY signal can be a more complex signal comprising encoded data, for example, results data and/or data relating to one or more errors detected and/or information defining the next test vector. By encoding the READY signal with error, or other, data, the first part, or indeed the second part, of the test can be halted or modified, for example in accordance with an iterative test regime. Although not mentioned above, it should be appreciated that in another embodiment the issuance of the INITIATE signal and the first READY signal can be concatenated by simply sending, for example, the INITIATE signal.

After transmission of the READY signal, the test system 102 awaits (410) receipt of the first stimulus signal of the first series of stimulus signals. Upon receipt of the first stimulus signal, the part of the processing resource 200 responsible for processing stimulus signals changes the state of the first armed flag to indicate that the processing resource 200 is busy processing the first stimulus signal and not ready to receive further stimulus signals. The exact mechanism for managing resources for processing of the stimulus signals is not central to the illustration of the invention contained herein and so for the purpose of clarity of description will not be described further herein. Whilst processing of the first stimulus signal is taking place, the test system 102 determines (412), by reference to the stored test vectors corresponding to the first series of stimulus signals, whether or not all the first series of stimulus signals have been received indicating that the first part of the test has been completed. If the first part of the test has not been completed, the test system 102 returns to monitoring (406) the status of the first armed flag to detect the change in status of the first armed flag, to determine when the test system 102 is ready to receive another, subsequent, stimulus signal from the first series of stimulus signals.

Whilst the above processing is taking place, the part of the processing resource 200 responsible for processing stimulus signals is independently processing the first stimulus signal. In this example, the first (and subsequent) stimulus signal can be processed so as to perform the EVM calculation mentioned above. Alternatively, or additionally, the first (and subsequent) stimulus signal can be measured to calculate peak power for each received stimulus signal. Upon completion of the processing of the first stimulus signal to a point where further stimulus signals can be received, the part of the processing resource 200 responsible for processing stimulus signals sets the first armed flag in the manner already described above (402 and 404).

Once the state of the first armed flag has changed, the test system 102 sends (408) another READY signal to the terminal 104 using the communication direction 112 between the test system 102 and the terminal 104 that is not being used for the first part of the test to communicate the first series of stimulus signals, and then awaits (410) receipt of the another stimulus signal from the first series of stimulus signals. This process is repeated for other, subsequent, stimulus signals in the first series of stimulus signals until the first part of the test has been deemed completed by the test system 102.

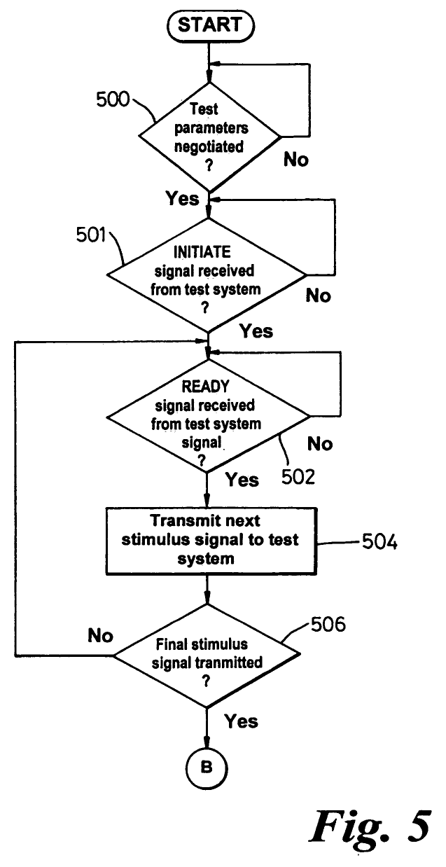

At the terminal 104 (FIG. 5), the terminal 104 firstly awaits (500) receipt of the test vectors constituting the first and second series of stimulus signals. The terminal 104 then awaits (501) receipt of the INITIATE signal sent by the test system 102 via the test input port 116. Upon receipt of the INITIATE signal, the terminal 104 subsequently awaits (502) receipt of the READY signal from the test system 102 via the RF port 308. When the READY signal is received from the test system 102, the terminal 104 transmits (504) the first stimulus signal from the first series of stimulus signals. The terminal 104 then determines (506) whether the first part of the test has been completed by virtue of having completed transmitting stimulus signals for all the test vectors corresponding to the first series of stimulus signals. If stimulus signals for all the test vectors corresponding to the first series of stimulus signals have been transmitted to the test system 102, the first part of the test is deemed completed and the above described process is terminated. Otherwise, the terminal 104 returns to awaiting (502) receipt of another READY signal from the test system 102 in response to which the another stimulus signal is transmitted to the test system 102. The above process of awaiting READY signals and responding by transmitting subsequent stimulus signals in the series of stimulus signals is repeated (502 to 506) until all the test vectors corresponding to the first series of stimulus signals have been transmitted. After determining (412) that a last stimulus signal in the first series of stimulus signals has been received, the test system 102 sends a final READY signal (414) to the terminal 104 indicating an end to the first part of the test.

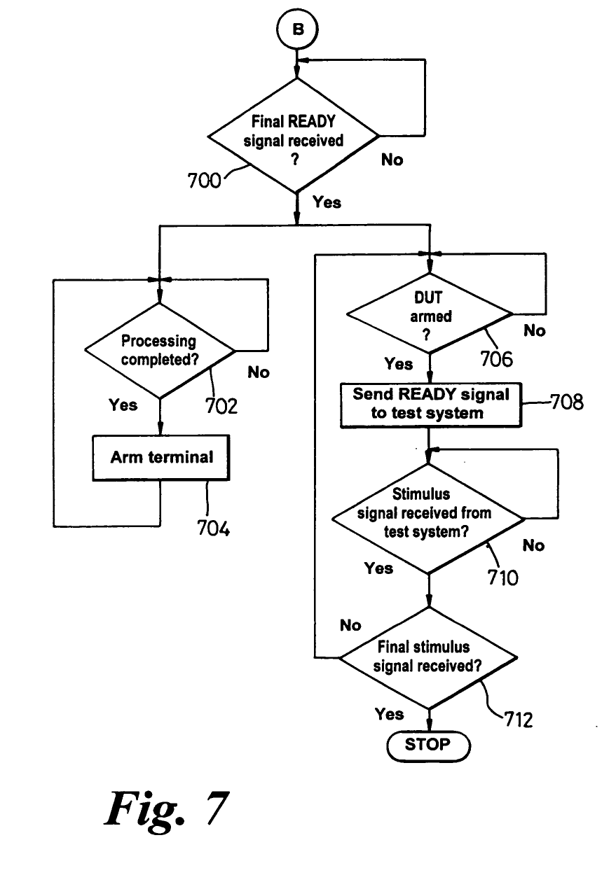

Referring to FIG. 7 first, the second part of the test, as indicated above, is initiated when the terminal 104 receives (700) the final READY signal mentioned above. After receiving the final READY signal at the end of the first part of the test, the terminal 104 can choose to execute any necessary processes (not shown), for example storing calibration data resulting from the first part of the test.

At the terminal 104, and in a like manner to the operation of the test system 102 in relation to the first part of the test, two separate processing threads are concurrently executed. Again, a first process executed by the processing resource 300 constitutes a first thread that addresses the issue of readiness of the processing resource 300 to receive stimulus signals. Consequently, after execution of the any necessary processes has been completed (702), the terminal 104 sets (704) an “armed” bit (not shown) to serve as a second armed flag indicative of the DUT having entered into an “armed” state. A concurrent second process constituting a second thread detects (706) the set armed flag, whereupon the terminal 104 transmits (708) a first READY signal to the test system 102. The setting, and detection of the setting, of the armed flag will be described in further detail later herein,

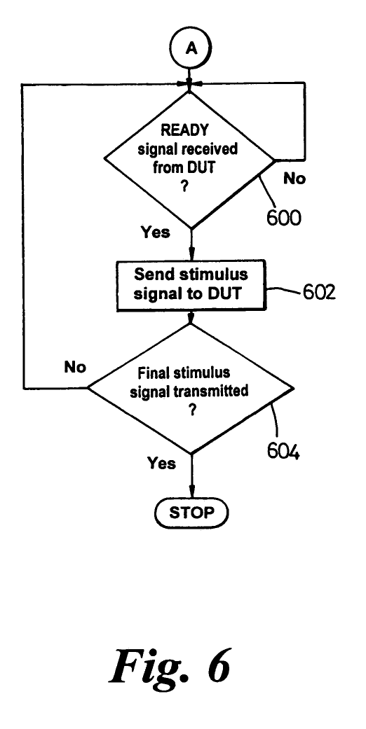

Referring to FIG. 6, the test system 102 awaits (600) receipt of the first READY signal from the terminal 104, indicative of the terminal 104 being armed. Upon receipt of the first READY signal from the terminal 104, the test system 102 transmits (602) a first stimulus signal from the second series of stimulus signals. The test system 102 then determines (604) whether the second part of the test has been completed by virtue of having completed transmission of stimulus signals for all the test vectors corresponding to the second series of stimulus signals. If stimulus signals for all the test vectors corresponding to the second series of stimulus signals have been transmitted by the test system 102, the second part of the test is deemed completed and the above described process is terminated. Otherwise, the test system 102 returns to awaiting (600) receipt of another READY signal from the terminal 104 in response to which another stimulus signal from the second series of stimulus signals is transmitted to the terminal 104. The above process of awaiting READY signals and responding by transmitting subsequent stimulus signals from the second series of stimulus signals is repeated (600 to 604) until all the test vectors corresponding to the second series of stimulus signals have been transmitted.

Referring back to FIG. 7, after transmission (708) of the READY signal, the second process executed by the terminal 104 awaits (710) receipt of the first stimulus signal from the second series of stimulus signals, whereupon a first process supported by a part of the processing resource 300 responsible for processing stimulus signals changes the state of the second armed flag to indicate that the DUT is not ready to process further stimulus signals. The exact mechanism for managing resources for processing of the stimulus signals is not central to the illustration of the invention contained herein and so for the purpose of clarity of description will not be described further herein.

Whilst processing of the first stimulus signal of the second series of stimulus signals is under way, the terminal 104 determines (712), by reference to the initially received test vectors corresponding to the second series of stimulus signals, whether or not all the second series of stimulus signals have been received indicating that the second part of the test has been completed. If the second part of the test has been completed, the second part of the test is terminated. Otherwise, the terminal 104 returns to monitoring (706) the state of the second armed flag to detect the change in state of the second armed flag, to determine when the terminal 104 is ready to receive another, subsequent, stimulus signal from the second series of stimulus signals.

In order to communicate readiness of the terminal 104 to receive subsequent stimulus signals from the second series of stimulus signals, the terminal 104 first needs to re-enter the “armed” state. However, the armed state cannot be re-entered until a part of the processing resource 300 responsible for processing received stimulus signals is ready to receive the another stimulus signal mentioned above. Consequently, in the first thread, and as already briefly described above, the first process executed by the processing resource 300 continuously monitors (702) the part of the processing resource 300 responsible for processing stimulus signals. If the part of the processing resource 300 supporting the first process is ready to process the another stimulus signal, then the processing resource sets (704) the armed bit (not shown) and the DUT is deemed to have entered the “armed” state.

If, whilst monitoring the status of the second armed flag, the second process determines that the state of the second armed flag has changed, i.e. that the DUT has entered the armed state, the terminal 104 transmits (708) another READY signal to the test system 102 using the unused communication direction between the terminal 104 and the test system 102, in this example in the transmit direction 110 of the FDD scheme supported by the terminal 104. The second process then continues executing in the same way as already described above in relation to the first stimulus signal from the second series of stimulus signals. Likewise, the above described aspects relating to the execution of the first and second processes by the terminal 104 (702 to 712) are repeated for other, subsequent, stimulus signals in the second series of stimulus signals until the terminal 104 has determined that all the second series of stimulus signals have been received and the test has been completed.

Of course, if processing time needs to be minimised to reduce latency further while the first and/or second parts of the test are taking place, any received stimulus signals can initially be sampled and then processed more fully once the first and/or second parts of the test have been completed, or earlier if processing resources permit. In such circumstances, the first and/or second armed flags can be returned to the armed state in less time than would be needed if processing of the any stimulus signals took place during the first and/or second parts of the test; the first and/or second armed flag would return to the armed state once each received stimulus signal has been sampled.

As will be readily understood by the skilled person, an unused, and hence available, communications direction of a duplexing scheme or interface is being used to communicate a response signal from the first wireless communications apparatus to the second wireless communications apparatus. The unused transmission direction is the opposite transmission direction to that being used to test, in the above example, the second wireless communications apparatus. Whilst, in the above example, the response signal is being communicated using the unused transmission direction, it should be appreciated that the stimlus and response signals can be part of a more complex handshaking process. The transmission of stimulus and response signals from the first wireless communications apparatus to the second wireless communications apparatus and from the second wireless communications apparatus to the first wireless communications apparatus can be encoded with control data to allow the test to proceed at the maximum speed and flexibility allowed for by the wireless communications apparatus, including the possibility of iterative testing, without the need for wait states or other unnecessary steps.

Whilst the above example has been described in the context of the FDD scheme, it should be appreciated that the principles of the above example can be employed in relation to any duplexing scheme, for example a Time Division Duplexing (TDD) scheme.

As briefly suggested above, in another embodiment, one or more stimulus signals of the first and/or second series of stimulus signals can be encoded with first information containing control data, or any of the response signals can be encoded with the first or second information containing the control data. For example, the one or more stimulus signal is encoded with parameters of a subsequent test vector, for example a test vector that corresponds to a next stimulus signal to be received by the terminal 104. The parameters can include, for example, an RF frequency, an RF amplitude, signal duration, an identity of a modulation format or encoded data and/or a type of measurement required. If one of the first or second wireless communications apparatus communicates to the other of the first or second wireless communications apparatus parameters corresponding to subsequent test vectors, it is only necessary, in the previous example, for an initial test vector to be communicated to the terminal 104 for each part of the test, the initial test vector being encoded with parameters of respective subsequent test vectors. Consequently, the test vectors can be calculated iteratively in real time during the first and/or second parts of the two-part test based upon the response signal received and/or the capabilities and needs of the device under test.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of pacing transmission of a series of stimulus signals from a first wireless communications apparatus and a second wireless communications apparatus in accordance with a duplexing scheme having a first transmission direction and a second transmission direction, the method comprising:
the first wireless communications apparatus transmitting a first stimulus signal as part of the series of stimulus signals to the second wireless communications apparatus in the first transmission direction or the second transmission direction;
the second wireless communications apparatus receiving the first stimulus signal; and
the second wireless communications apparatus transmitting a response signal to the first wireless communications apparatus in a remaining unused one of the first transmission direction or the second transmission direction.

2. A method as claimed in claim 2, wherein the first transmission direction is an uplink direction and the second transmission direction is a downlink direction.

3. A method as claimed in claim 1, further comprising:
encoding at least one of the stimulus signals with first information.

4. A method as claimed in claim 3, wherein the first information relates to at least one test parameter of a stimulus signal to succeed the at least one of the stimulus signals.

5. A method as claimed in claim 1, wherein the response signal is encoded with first or second information.

6. A method as claimed in claim 1, wherein a presence of the response signal is indicative of readiness by the first wireless communications apparatus to receive a second and subsequent stimulus signal as part of the series of stimulus signals.

7. A computer program element comprising computer program code means to make a computer execute the method as claimed in claim 1.

8. A wireless communications apparatus capable of generating a series of stimulus signals and operating in accordance with a duplexing scheme having a first transmission direction and a second transmission direction, the apparatus comprising:
a processing resource coupled to a transmitter for transmitting a first stimulus signal as part of the series of stimulus signals to another wireless communications apparatus in the first transmission direction or the second transmission direction; wherein:
the processing resource is coupled to a receiver and arranged to await, when in use, receipt of a response signal from another wireless communications apparatus in a remaining unused one of the first transmission direction or the second transmission direction.

9. An apparatus as claimed in claim 8, wherein the response signal is indicative of readiness by the another wireless communications apparatus to receive a second and subsequent stimulus signal as part of the series of stimulus signals.

10. A stimulus response measurement system comprising a first wireless communications apparatus capable of communicating a series of stimulus signals to a second wireless communications apparatus in accordance with a duplexing scheme providing a first transmission direction and a second transmission direction, the system comprising:
the first wireless communications apparatus arranged to transmit, when in use, a first stimulus signal in the series of stimulus signals to the second wireless communications apparatus in the first transmission direction or the second transmission direction;
the second wireless communications apparatus arranged to receive, when in use, the first stimulus signal; and
the second wireless communications apparatus arranged to transmit, when in use, a response signal to the first wireless communications apparatus in a remaining unused one of the first transmission direction or the second transmission direction.
